(19) United States
(12) Patent Application Publication
(10) Pub. No.: US 2012/0057272 A1
(43) Pub. Date: Mar. 8, 2012

(54) LAMINATED CERAMIC CAPACITOR

(75) Inventors: Tomotaka Hirata, Nagaokakyo-shi (JP); Mitsuhiro Kusano, Nagaokakyo-shi (JP)

(73) Assignee: MURATA MANUFACTURING CO., LTD., Nagaokakyo-shi (JP)

(21) Appl. No.: 13/222,012

(22) Filed: Aug. 31, 2011

(30) Foreign Application Priority Data
Sep. 6, 2010 (JP) 2010-198579

(51) Int. Cl. H01G 4/12

(52) U.S. Cl. 361/321.4

(57) ABSTRACT

A laminated ceramic capacitor which has high moisture resistance includes a laminated body including a plurality of stacked ceramic layers and internal electrodes placed between the ceramic layers; and an external electrode formed on an outer surface of the laminated body and electrically connected to the internal electrodes, and the laminated ceramic capacitor has the feature that the ceramic layers contain CaZrO₃ as their main constituent, and the feature that a layer containing a (Ba, Ca)—Zn—Si based oxide (including an oxide containing no Ca) is formed between the laminated body and the external electrode.

### BACKGROUND OF THE INVENTION

1. Field of the Invention

The present invention relates to a laminated ceramic capacitor.

2. Description of the Related Art

A laminated ceramic capacitor has, for example, a laminated body including a plurality of stacked ceramic layers and internal electrodes placed between ceramic layers; and an external electrode formed on an outer surface of the laminated body and electrically connected to the internal electrodes.

As a process for forming the external electrode, a method has been commonly used in which a conductive paste composed of a metal powder (conductive constituent) such as Cu, Ni, Ag, and Ag—Pd, combined with glass frit, an organic binder, a solvent, etc. is applied onto an end of the outer surface of the laminated body, and subjected to firing. Furthermore, a technique is known in which a layer is obtained by reaction of the ceramic with the glass frit between the external electrode and the laminated body. This layer has, for example, the role of preventing the ingress of moisture or flux into the laminated body.

For example, Japanese Patent Application Laid-Open No. 10-135063 discloses a technique in which a glass paste containing Si as its main constituent is applied onto both end surfaces of a laminated body to form glass-rich regions with a Si abundance ratio of 60% or more, and a reactive layer is formed between the regions and external electrodes.

### SUMMARY OF THE INVENTION

However, the technique disclosed in Japanese Patent Application Laid-Open No. 10-135063 has the problem of requiring a large number of man-hours because of the application of the glass paste containing Si as its main constituent. In addition, when the ceramic layers contain CaZrO₃ as their main constituent, the technique has the problem of the ceramic and glass being altered, thereby leading to degradation of the characteristics after a moisture resistance loading test, because Ca in the ceramic layers excessively reacts with Si.

An object of the present invention is, in view of the problem described above, to provide a laminated ceramic capacitor which provides improved moisture resistance in the case of a ceramic layer containing CaZrO₃ as its main constituent.

A laminated ceramic capacitor according to the present invention includes a laminated body including a plurality of stacked ceramic layers and internal electrodes placed between ceramic layers; and an external electrode formed on an outer surface of the laminated body and electrically connected to the internal electrodes, and the laminated ceramic capacitor has the feature that the ceramic layers contain CaZrO₃ as their main constituent, and the feature that a layer containing a (Ba, Ca)—Zn—Si based oxide (including an oxide containing no Ca) is formed between the laminated body and the external electrode.

In addition, the (Ba, Ca)—Zn—Si based oxide is preferably a (Ba, Ca)ZnSiO₄ crystalline phase in the laminated ceramic capacitor according to the present invention.

In the laminated ceramic capacitor according to the present invention, the layer containing a (Ba, Ca)—Zn—Si based oxide (including an oxide containing no Ca) is formed between the laminated body and the external electrode. The presence of the layer allows the Ca constituent in the ceramic layers to be prevented from diffusing into the external electrode, which can thus suppress degradation of the chemical stability of the glass in the ceramic layers and in the external electrode.

In addition, the presence of the layer allows the ingress of moisture or flux into the laminated body to be prevented. Therefore, a laminated ceramic capacitor can be achieved which has high moisture resistance.

### BRIEF DESCRIPTION OF THE DRAWINGS

FIG. 1 is a cross-sectional view of a laminated ceramic capacitor according to the present invention;

FIG. 2 is a SEM photograph of a cross section from the LT surface in a laminated ceramic capacitor of sample number 2A; and

FIG. 3 is a diagram showing a μ-XRD chart for a reactive layer in FIG. 2.

### DETAILED DESCRIPTION OF THE INVENTION

An embodiment of the present invention will be described below.

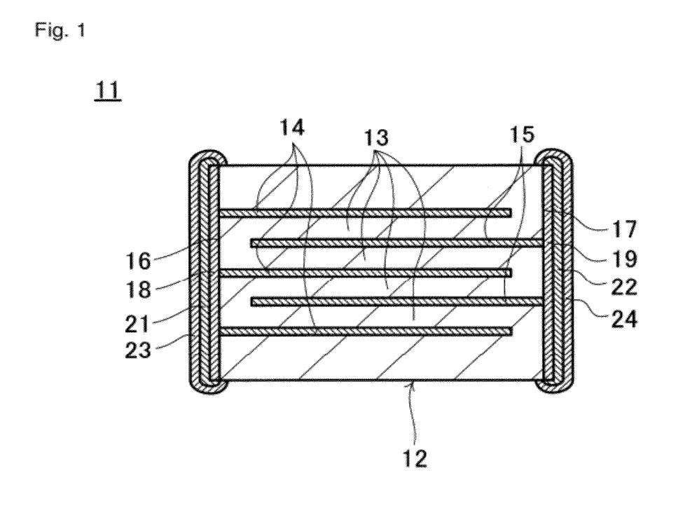

FIG. 1 is a cross-sectional view of a laminated ceramic capacitor according to the present invention.

The laminated ceramic capacitor 11 includes a laminated body 12. The laminated body 12 includes a plurality of stacked ceramic layers 13, and internal electrodes 14 and 15 placed along interfaces between the plurality of ceramic layers 13. The internal electrodes 14 and 15 are formed so as to reach the outer surface of the laminated body 12. Furthermore, the internal electrodes 14 reach one end surface 16 of the laminated body 12 and the internal electrodes 15 reach the other end surface 17 of the laminated body 12, and are arranged alternately with the ceramic layers 13 interposed therebetween within the laminated body 12.

The materials for the internal electrodes 14 and 15 include, for example, nickel, a nickel alloy, copper, and a copper alloy, as well as a material containing other base metals as its main constituent.

External electrodes 18 and 19 are formed on the outer surface of the laminated body 12. In FIG. 1, the external electrodes 18 and 19 are respectively formed at least on the end surfaces 16 and 17 of the laminated body 12. The external electrode 18 on the end surface 16 is electrically connected to the internal electrodes 14. In addition, the external electrode 19 on the end surface 17 is electrically connected to the internal electrodes 15.

The external electrodes 18 and 19 are formed, for example, by applying a conductive paste to the end surfaces 16 and 17 of the laminated body 12 and firing the conductive paste. The conductive paste contains a metal powder and glass frit. The materials for the external electrodes 18 and can include the same materials as for the internal electrodes 14 and 15. Alternatively, the materials for the external electrodes 18 and 19 include a material containing silver, palladium, a silver-palladium alloy, etc. as its main constituent.

If necessary, first plating layers 21 and 22 containing nickel, copper, or the like as their main constituent are formed on the external electrodes 18 and 19, respectively. Further, second plating layers 23 and 24 containing solder, tin, or the like as their main constituent are formed respectively thereon.

In this type of laminated ceramic capacitor 11, the ceramic layers 13 contain CaZrO₃ as their main constituent. Furthermore, a layer containing a (Ba, Ca)—Zn—Si based oxide (including an oxide containing no Ca) in the present embodiment is formed between the laminated body 12 and the external electrodes 18 and 19. The presence of the layer allows the Ca constituent in the ceramic layers 13 prevents from diffusing into the external electrodes. More specifically, it is presumed that the presence of Ba in the (Ba, Ca)—Zn—Si based oxide at the interfaces between the laminated body 12 and the external electrodes 18 and 19 makes Ba more likely to become charged by thermal energy than Ca because Ba has a larger ionic radius and also is smaller in electronegativity than Ca, thus suppressing the diffusion of the Ca constituent into the external electrode.

Therefore, degradation of the chemical stability of the glass can be suppressed in the ceramic layers 13 and the external electrodes 18 and 19. In addition, the presence of the layer allows the ingress of moisture or flux into the laminated body 12.

This layer preferably contains a (Ba, Ca)ZnSiO₄ crystalline phase. In this case, the chemical stability of the layer itself is improved to make it possible to further prevent the ingress of moisture or flux into the laminated body 12. Therefore, the moisture resistance can be further improved.

A laminated ceramic capacitor according to the present invention is, as an example, manufactured as follows.

First, ceramic green sheets to serve as the ceramic layers 13 are formed. Specifically, an organic binder and a solvent are added to and mixed with a ceramic raw material powder containing CaZrO₃ as its main constituent to prepare a slurry from the mixture. This slurry is then subjected to sheet forming, for example, in accordance with a doctor blade method or the like, thereby forming ceramic green sheets.

Next, a raw laminated body is formed. Specifically, conductive paste films to serve as the internal electrodes 14 or 15 are formed on the specific ceramic green sheets. The conductive paste films are formed, for example, by a screen printing method. Then, the multiple ceramic green sheets, including the ceramic green sheets with the conductive paste films formed thereon, are stacked, subjected to pressure bonding, and then cut, if necessary.

Next, the raw laminated body is fired. Thus, the fired laminated body 12 is obtained as shown in FIG. 1.

Next, the external electrodes 18 and 19 are formed on the respective end surfaces 16 and 17 of the laminated body 12 so as to be electrically connected to the internal electrodes 14 and 15. The external electrodes 18 and 19 are formed by applying a conductive paste to the laminated body 12 and firing the conductive paste. The conductive paste contains a metal powder and glass frit, and the appropriate selection of constituent elements for the glass frit allows the formation of the layer containing the (Ba, Ca)—Zn—Si based oxide.

Then, if necessary, nickel plating, copper plating, or the like is carried out to form the first plating layers 21 and 22, respectively, on the external electrodes 18 and 19. Then, solder plating, tin plating, or the like is carried out to form the second plating layers 23 and 24, respectively, on the first plating layers 21 and 22.

The laminated ceramic capacitor 11 is manufactured in the way described above.

Next, an experimental example will be described which was carried out in order to confirm the advantageous effect of the present invention.

### Experimental Example 1

In Experimental Example 1, laminated ceramic capacitors were prepared while changing the glass frit in a conductive paste for external electrodes.

(A) Preparation of Laminated Ceramic Capacitor

First, ceramic green sheets to serve as ceramic layers were formed. Specifically, an organic binder and a solvent were added to and mixed with a ceramic raw material powder containing CaZrO₃ as its main constituent to prepare a slurry from the mixture. This slurry was subjected to sheet forming.

Next, a raw laminated body was formed. Specifically, a conductive paste containing nickel as its main constituent was printed onto the specific ceramic green sheets to form conductive paste films to serve as internal electrodes. Then, the multiple ceramic green sheets, including the ceramic green sheets with the conductive paste films formed thereon, were stacked, subjected to pressure bonding, and then cut.

The raw laminated body was then subjected to firing at a temperature of 1200° C. in a reducing atmosphere, thereby providing a fired laminated body. The fired laminated body was thereafter subjected to barreling to expose the internal electrodes at the end surfaces.

Next, external electrodes were formed. Specifically, a conductive paste was applied onto end surfaces of the laminated body.

Then, the conductive paste was dried, and then heated at 900° C. in a nitrogen atmosphere for firing.

It is to be noted that a conductive paste containing copper, glass frit, and an organic vehicle was used as the conductive paste for the external electrodes. Then, samples of sample numbers 1 to 7 were prepared while changing the type of the glass frit contained in the conductive paste. The compositions for the glass frit are as shown in Table 1. The conductive paste used had a volume ratio of 20:5:75 of the copper powder, the glass frit, and the organic vehicle. In addition, an organic vehicle was used which contained an acrylic resin at 20 vol %.

TABLE 1

| Sample | Glass Constituent [wt %] | | | | | | |
|---|---|---|---|---|---|---|---|
| Number | BaO | ZnO | SiO₂ | B₂O₃ | Al₂O₃ | ZrO₂ | Li₂O |
| 1 | 42 | 21 | 10 | 16 | 6 | — | 5 |
| 2 | 9 | 31 | 13 | 37 | 5 | — | 5 |
| 3 | 20 | 40 | 12 | 28 | — | — | — |
| 4 | 65 | 9 | 15 | — | 5 | 3 | 3 |
| 5 | — | 16 | 35 | 25 | 9 | 8 | 7 |
| 6 | — | 34 | 45 | 20 | 1 | — | — |
| 7 | 9 | — | 28 | 42 | 5 | 6 | 10 |

After the formation of the external electrodes, the samples of sample numbers 1 to 7 were each divided into two groups depending on whether or not a heat treatment was carried out, and the two groups of samples were respectively referred to as sample numbers 1A to 7A and 1B to 7B. Among these samples, only the samples 1A to 7A were subjected to a heat treatment at 800° C. in a nitrogen atmosphere.

Subsequently, a Ni plating layer and a Sn plating layer were formed on the external electrodes by a barrel plating method for each of the samples of sample numbers 1A to 7A and sample numbers 1B to 7B.

In this way, the laminated ceramic capacitors were obtained with a width (W) of 1.0 mm, a length (L) of 0.5 mm, and a thickness (T) of 0.5 mm.

(B) Characterization

The laminated ceramic capacitors obtained were evaluated for various types of characteristics.

First, the reactive layer between the laminated body and the external electrode was subjected to a thickness measurement. Specifically, the laminated ceramic capacitors were subjected to resin filling, and to polishing until the width was reduced down to ½ in the width (W) direction so that the LT surfaces were able to be observed. Then, the polished surface was observed under a SEM to measure the thickness of the reactive layer.

Next, the main constituent of the reactive layer was identified. Specifically, as in the case of the SEM observation, polishing was carried out so that the LT surface was able to be observed. Then, the external electrode exposed at the polished surface was removed by an ion milling method. Subsequently, the part of the reactive layer was subjected to a measurement by the μ-XRD method to identify the main constituent of the reactive layer. The composition exhibiting the highest XRD intensity was regarded as the main constituent among the identified compositions.

Next, the internal defect incidence rate was obtained. Specifically, the incidence rates for samples with an internal defect caused were obtained by ultrasonic inspection. The inspection was carried out on 100000 samples for each sample number.

Next, the percent defective was obtained after a moisture resistance loading test. The moisture resistance loading test was carried out under the conditions of a temperature of 85° C., a humidity of 85%, and a test voltage of 50 V for 1000 hours. The insulation resistance after the test was measured, and the samples with an insulation resistance of 10¹¹Ω or less were determined as defectives, and the number used to obtain the percent defective. The test was carried out on 100 samples for each sample number.

Next, the percent defective was obtained after a pressure cooker bias test (PCBT). The PCBT was carried out under the conditions of a temperature of 125° C., a pressure of 1.2 atm, a humidity of 95%, and a test voltage of 50 V for 500 hours. The insulation resistance after the test was measured, and samples with an insulation resistance of 10¹¹Ω or less were determined as defectives. The test was carried out on 100 samples for each sample number. The PCBT is a test under severer condition than that for the moisture resistance loading test, because the PCBT was carried out under pressure.

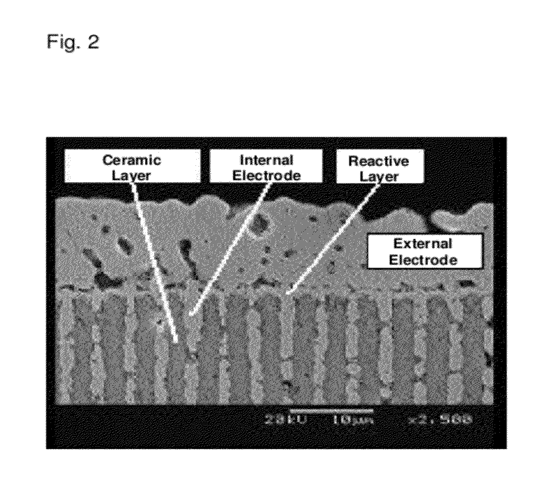

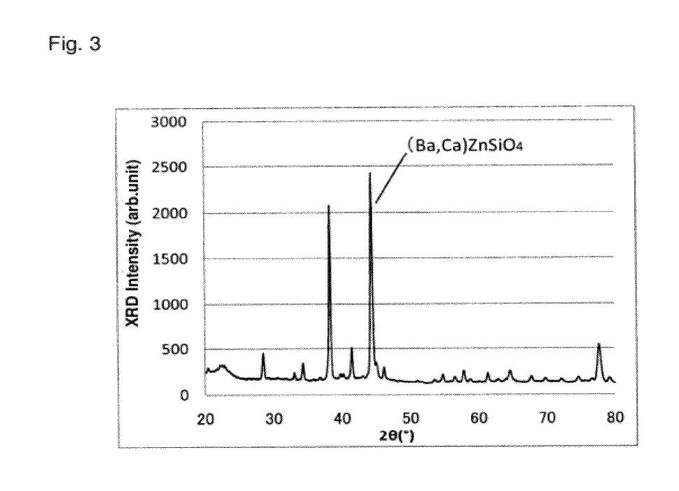

FIG. 2 shows a SEM photograph of a cross section from the LT surface in the laminated ceramic capacitor of sample number 2A. In addition, FIG. 3 shows the μ-XRD measurement result for the reactive layer in FIG. 2. In addition, Table 2 shows the results of the thickness of the reactive layer, the main constituent of the reactive layer, the internal defect incidence rate, the percent defective after the moisture resistance loading test, and the percent defective after the PCBT.

TABLE 2

| | | | | | Percent | |
|---|---|---|---|---|---|---|
| | | | | | Defective | |
| | | | | | after | |
| | | Thickness | | Internal | Moisture | |
| | | of | | Defect | Resistance | Percent |
| | | Reactive | Main Constituent | Incidence | Loading | Defective |
| | Heat | Layer | of Reactive | Rate | Test | after PCBT |
| Sample | Treatment | [μm] | Layer | [ppm] | [%] | [%] |
| 1A | Yes | 1 | (Ba,Ca)ZnSiO₄ | 0 | 0 | 0 |
| 1B | No | 1 | (Ba,Ca)—Zn—Si | 0 | 0 | 3 |
| | | | Based Oxide | | | |
| 2A | Yes | 2 | (Ba,Ca)ZnSiO₄ | 0 | 0 | 0 |
| 2B | No | 2 | (Ba,Ca)—Zn—Si | 0 | 0 | 4 |
| | | | Based Oxide | | | |
| 3A | Yes | 3 | (Ba,Ca)ZnSiO₄ | 0 | 0 | 0 |
| 3B | No | 3 | (Ba,Ca)—Zn—Si | 0 | 0 | 2 |
| | | | Based Oxide | | | |
| 4A | Yes | 0.5 | (Ba,Ca)ZnSiO₄ | 0 | 0 | 0 |
| 4B | No | 0.5 | (Ba,Ca)—Zn—Si | 0 | 0 | 3 |
| | | | Based Oxide | | | |
| 5A* | Yes | 7 | ZrO₂ | 90 | 9 | 21 |
| 5B* | No | 7 | No Crystalline | 240 | 15 | 45 |
| | | | Phase | | | |
| 6A* | Yes | 8 | SiO₂ | 10 | 2 | 15 |
| 6B* | No | 8 | SiO₂ | 20 | 6 | 28 |
| 7A* | Yes | 5 | AlZr Oxide | 10 | 4 | 13 |
| 7B* | No | 5 | No Crystalline | 220 | 13 | 48 |
| | | | Phase | | | |

*outside the scope of the present invention

It is determined from FIG. 2 that a reactive layer is formed at the interface between the laminated body and the external electrode in the case of sample number 2A. In addition, the achievement of a (Ba, Ca)ZnSiO₄ crystalline phase is determined from the μ-XRD result for the reactive layer in FIG. 3.

As can be seen from Table 2, in the case of sample numbers 1A through 4B with the reactive layer containing a (Ba, Ca)—Zn—Si based oxide as its main constituent, there was no internal defect, and no defectives even after the moisture resistance loading test. On the other hand, there were internal defects and defectives after the moisture resistance loading test in the case of sample numbers 5A through 7B with the reactive layer containing no (Ba, Ca)—Zn—Si based oxide as its main constituent.

In addition, a (Ba, Ca)ZnSiO₄ crystalline phase was formed as the reactive layer in the case of sample numbers 1A, 2A, 3A, and 4A subjected to the heat treatment. No defective were found in these samples even after the severer PCBT than the moisture resistance loading test.

What is claimed is:

1. A laminated ceramic capacitor comprising:
a laminated body comprising a plurality of stacked ceramic layers and internal electrodes disposed between ceramic layers; and
an external electrode on an outer surface of the laminated body and electrically connected to an internal electrode, wherein
the ceramic layers comprise CaZrO₃ as their main constituent, and
a layer containing a (Ba, Ca)—Zn—Si oxide or a Ba—Zn—Si oxide is disposed between the laminated body and the external electrode.

2. The laminated ceramic capacitor according to claim 1, wherein the oxide comprises a (Ba, Ca)ZnSiO₄ crystalline phase.

3. The laminated ceramic capacitor according to claim 2, wherein the laminated body contains at least two internal electrodes disposed at different interfaces between adjacent ceramic layers, two external electrodes electrically connected to different internal electrodes disposed on an outer surface of the laminated body, and wherein the oxide layer is disposed between the laminated body and both external electrodes.

4. The laminated ceramic capacitor according to claim 3, wherein the oxide layer disposed between the laminated body and the external electrodes is a boron-containing glass.

5. The laminated ceramic capacitor according to claim 4, wherein the boron-containing glass contains at least one of Al, Zr and Li.

6. The laminated ceramic capacitor according to claim 3, wherein the oxide layer disposed between the laminated body and the external electrodes is a Al, Zr, and Li-containing glass.

7. The laminated ceramic capacitor according to claim 1, wherein the laminated body contains at least two internal electrodes disposed at different interfaces between adjacent ceramic layers, two external electrodes electrically connected to different internal electrodes disposed on an outer surface of the laminated body and, and wherein the oxide layer is disposed between the laminated body and both external electrodes.

8. The laminated ceramic capacitor according to claim 7, wherein the oxide layer disposed between the laminated body and the external electrodes is a boron-containing glass.

9. The laminated ceramic capacitor according to claim 8, wherein the boron-containing glass contains at least one of Al, Zr and Li.

10. The laminated ceramic capacitor according to claim 8, wherein the oxide layer disposed between the laminated body and the external electrodes is a Al, Zr, and Li-containing glass.

11. The laminated ceramic capacitor according to claim 8, wherein the oxide comprises a (Ba, Ca)—Zn—Si oxide.

12. The laminated ceramic capacitor according to claim 11, wherein the oxide comprises a (Ba, Ca)ZnSiO₄ crystalline phase.

13. The laminated ceramic capacitor according to claim 8, wherein the oxide comprises a Ba—Zn—Si oxide.

14. The laminated ceramic capacitor according to claim 7, wherein the oxide comprises a (Ba, Ca)—Zn—Si oxide.

15. The laminated ceramic capacitor according to claim 14, wherein the oxide comprises a (Ba, Ca)ZnSiO₄ crystalline phase.

16. The laminated ceramic capacitor according to claim 7, wherein the oxide comprises a Ba—Zn—Si oxide.
